(19) United States
(12) Patent Application Publication
(10) Pub. No.: US 2016/0106613 A1
(43) Pub. Date: Apr. 21, 2016

(54) WHOLE BODY EXERCISE MACHINE CAPABLE OF CIRCULAR ORBITAL MOVEMENT OF WAIST

(71) Applicants: Seung Hoon Oh, Seoul (KR); Overtech Co., Ltd., Anyang-si, Gyeonggi-do (KR)

(72) Inventor: Seung Hoon Oh, Seoul (KR)

(21) Appl. No.: 14/786,979

(22) PCT Filed: Mar. 21, 2014
(86) PCT No.: PCT/KR2014/002379

§ 371 Date: Oct. 25, 2015

(30) Foreign Application Priority Data
Apr. 25, 2013 (KR) 10-2013-0046248

(51) Int. Cl. A61H 1/00

(52) U.S. Cl. CPC A61H 1/001; A61H 2205/088; A61H 2203/0456

(57) ABSTRACT

The present invention relates to a whole body exercise machine, and more specifically, to a whole body exercise machine capable of a circular orbital motion of waist and of strengthening the waist, back and abdomen through longitudinal rotation and lateral-torsional rotation of the waist, back and abdomen. The whole body exercise machine which is for exercising an upper body, waist and lower body and which is capable of a circular orbital motion of the waist according to the present invention comprises: an upper body exercise part which supports a head or shoulder of a human body, enables an upper body exercise and moves in association with a waist exercise part; the waist exercise part which supports the waist or hip of the human body and enables the circular orbital motion; and a lower body exercise part which supports a leg of the human body and is horizontally movable to the right and left. The waist exercise part comprises a rotating board which rotates around a rotary shaft. One or more ball casters are formed on a lower end surface of the rotating board. One or more fixation clamps for fixing the rotating board are formed on an outer circumferential surface of the rotating board in a circumferential direction.

### TECHNICAL FIELD

The present invention relates to a whole body exercise machine, and more particularly to a whole body exercise machine capable of a circular orbital motion of waist and of strengthening the waist, back and abdomen through longitudinal rotation and lateral-torsional rotation of the waist, back and abdomen.

### BACKGROUND ART

Due to rigid posture, excessive work or aging, our body is exposed to a degenerative disc disease in which there occur problems in waist, back, abdomen, knee, etc., of the body, a scoliosis in which the spine is curved, myofascial pain causing hip joint pain and back pain, stress type growth, excessive abdomen fat, etc. Modern people take exercise for a lot of time so as to solve the above-mentioned problems, or are helped by a variety of exercise machines or a professional trainer.

In accordance with such a trend, various exercise machines for each part of the body and whole body exercise machines are launched are developed.

For example, a countless number of exercise machines including, for example, a neck and shoulder exercise machine, an abdominal muscle exercise machine, an electric-powered leg joint exercise machine, a lower body exercise machine, an aerobic exercise machine, a spine correction exercise machine, a boxing game exercise machine, a pelvic muscle contraction exercise machine, a body shape correction whole body exercise machine, a back acupressure machine, a grip exercise machine, a shoulder twist exercise machine, a multi-purpose exercise machine, a whole body exercise machine, and the like, are being used and developed.

A whole body exercise machine patent-registered by the present applicant is disclosed in Korean Registered Patent Publication No. 10-1254940 (exercise machine for strengthening waist, back, and abdomen).

The exercise machine for strengthening waist, back, and abdomen, disclosed in Korean Registered Patent Publication No. 10-1254940, can be said to be very efficient in that a whole body exercise is possible according to a mechanism in which head, waist and even legs are interworked with each other.

In particular, in waist exercise, the exercise machine for strengthening waist, back, and abdomen disclosed in Korean Registered Patent Publication No. 10-1254940 is different from existing whole body exercise machines in that a lateral movement and a longitudinal movement can be performed parallel to each other. However, the applicant has realized that there is an inconvenience that a connection adaptor which interconnects quadrangular frames fastened for the lateral movement and longitudinal movement should be loosened and the waist portion frame should be rotated in a 90 degree direction, and then be fixed.

Also, the applicant has realized that, in the exercise machine for strengthening waist, back, and abdomen, disclosed in Korean Registered Patent Publication No. 10-1254940, when a circular orbital motion is performed, a balance of the cam and link should be achieved, and when the circular orbital motion stops, the machine is vulnerable to safety accidents due to the sudden stop of the rotation.

Also, the applicant has realized that, when the waist portion is rotated, it is necessary to control a right and left movement and an impact caused by the right and left movement.

### DISCLOSURE

### Technical Problem

The present invention is designed to solve the above-mentioned problems and provides a whole body exercise machine which makes waist, back and abdomen of a human body flexible, enhances the muscular strength, and allows the waist to perform the circular orbital motion.

The present invention provides a balance control device for cam and link rotation, that is to say, an inadequate safety device of the existing exercise machine for strengthening waist, back, and abdomen, which has been patent-registered by the present applicant.

Also, the present invention provides a whole body exercise machine capable of a circular orbital motion of waist, which allows an angle of a waist frame to be easily controlled for the purpose of a lateral movement and a longitudinal movement of the waist portion.

Also, the present invention provides a whole body exercise machine capable of a circular orbital motion of waist, which allows the waist portion to perform a right and left movement at the time of performing the lateral movement by forming the waist portion in the form of a double support, and which can be freely used regardless of the size of the human body.

### Technical Solution

To solve the above-described problems, the present invention provides a whole body exercise machine which is for exercising an upper body, waist and lower body and enables a circular orbital motion of the waist. The whole body exercise machine includes: an upper body exercise part which supports a head or shoulder of a human body, enables an upper body exercise and moves in association with a waist exercise part; the waist exercise part which supports the waist or hip of the human body and enables the circular orbital motion; and a lower body exercise part which supports a leg of the human body and is horizontally movable to the right and left. The waist exercise part includes a rotating board which rotates around a rotary shaft. One or more ball casters are formed on a lower end surface of the rotating board. One or more fixation clamps for fixing the rotating board are formed on an outer circumferential surface of the rotating board in a circumferential direction.

Here, the circular orbital motion may be made by a vertically formed main link, a cam of which one end is connected to an end of the main link and the other end is connected to a link driven shaft, and a motor and a decelerator which transmit a driving force to the cam. A balance safety device may be formed, of which one end is connected to a predetermined position of the main link by a connection shaft including a ball bearing and the other end is connected to a fixed balance support by the connection shaft including a ball bearing.

Here, a shaft having an adjustable height may be connected under the waist exercise part, and a waist support on which a slider plate is formed may be located on the waist exercise part. A waist support table may be located on the slider plate. Right and left positions of the waist support table may be adjusted by the slider plate. A spring for giving a cushion at the time of adjusting the position may be provided in the center of the slider plate.

Here, a waist support may be formed on the waist exercise part. A waist auxiliary support may be formed on one side of the waist support. The waist auxiliary support may be coupled to an upper body connection shaft. The upper body connection shaft may be connected to the upper body exercise part through the mediation of a link ball bearing.

### Advantageous Effects

According to the above-described solution of the present invention, it is possible to provide a whole body exercise machine which makes waist, back and abdomen of a human body flexible, enhances the muscular strength, and allows the waist to perform the circular orbital motion.

Also, it is possible to provide a balance control device for cam and link rotation, that is to say, an inadequate safety device of the existing exercise machine for strengthening waist, back, and abdomen, which has been patent-registered by the present applicant, and possible to provide a whole body exercise machine capable of a circular orbital motion of waist, which allows an angle (0 to 90 degrees) of a frame to be easily controlled for the purpose of a lateral movement and a longitudinal movement of the waist portion, which allows the waist portion to perform a right and left movement at the time of performing the lateral movement by forming the waist portion in the form of a double support, and which can be freely used regardless of the size of the human body.

### DESCRIPTION OF DRAWINGS

FIG. 1 is a front view showing that a whole body exercise machine capable of a circular orbital motion of waist in accordance with an embodiment of the present invention performs a lateral movement;

FIG. 2 is a right side view of a waist exercise part of FIG. 1;

FIG. 3 is a front view showing that the whole body exercise machine capable of a circular orbital motion of waist in accordance with the embodiment of the present invention performs a longitudinal movement;

FIG. 4 is a right side view of the waist exercise part of FIG. 3;

FIG. 5 is a left side of an upper body exercise part in the whole body exercise machine capable of a circular orbital motion of waist in accordance with the embodiment of the present invention;

FIG. 6 is a right side of a lower body exercise part in the whole body exercise machine capable of a circular orbital motion of waist in accordance with the embodiment of the present invention;

FIG. 7 is a schematic view showing a lateral movement mechanism of the whole body exercise machine capable of a circular orbital motion of waist in accordance with the embodiment of the present invention; and

FIG. 8 is a schematic view showing a longitudinal movement mechanism of the whole body exercise machine capable of a circular orbital motion of waist in accordance with the embodiment of the present invention.

### MODE FOR INVENTION

Hereafter, the structure, operation and consequent effects of a whole body exercise machine capable of a circular orbital motion of waist in accordance with an embodiment of the present invention will be described with reference to the accompanying drawings.

Through the whole body exercise machine capable of a circular orbital motion of waist in accordance with the embodiment of the present invention (hereafter, referred to as a whole body exercise machine), a person is able to take a whole body exercise including the upper body, waist, and lower body of the person while lying down. In particular, the waist of the person is able to perform a lateral movement and a longitudinal movement.

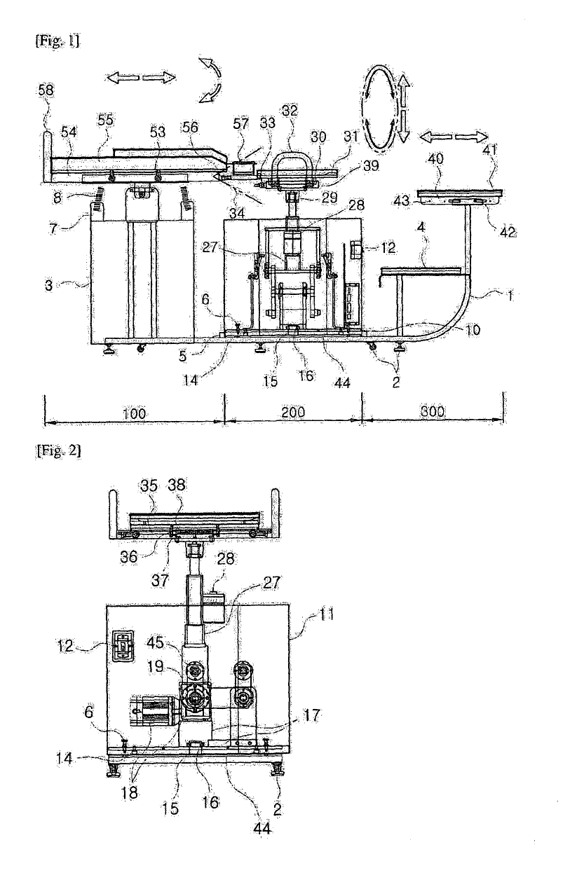

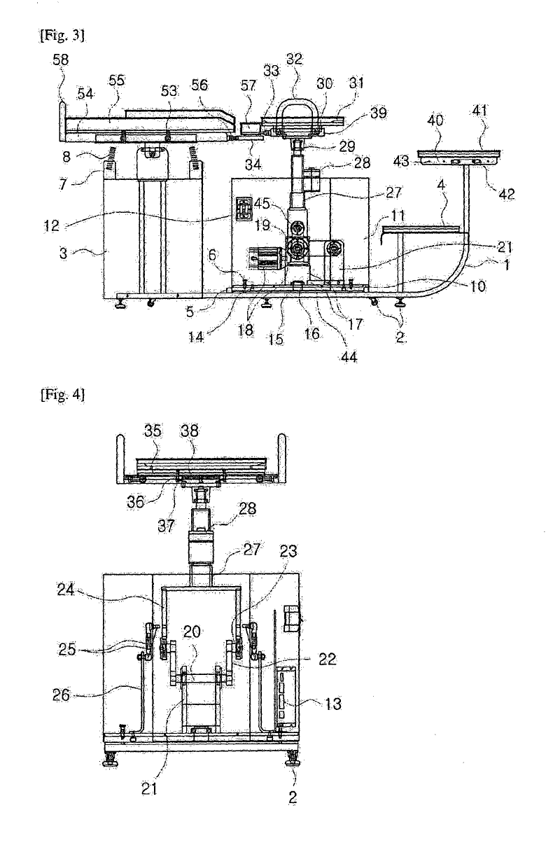

FIGS. 1 and 2 are front views that the waist portion performs a lateral movement. FIGS. 3 and 4 are front views that a waist portion performs a lateral movement.

In the whole body exercise machine according to the embodiment of the present invention, in a state where an upper body exercise part and a lower body exercise part of the whole body exercise machine are fixed, the angle of a waist exercise part located between the upper body exercise part and the lower body exercise part can be adjusted within a range from 0 to 90 degrees. That is, when the waist exercise part is rotated by 90 degrees in the state of FIG. 1 (in the state where the waist portion performs the lateral movement), the waist exercise part becomes in the state of FIG. 3 (in the state where the waist portion performs the longitudinal movement).

FIG. 1 is a front view showing that the whole body exercise machine capable of a circular orbital motion of waist in accordance with the embodiment of the present invention performs the lateral movement. FIG. 2 is a right side view of the waist exercise part of FIG. 1.

FIG. 3 is a front view showing that the whole body exercise machine capable of a circular orbital motion of waist in accordance with the embodiment of the present invention performs the longitudinal movement. FIG. 4 is a right side view of the waist exercise part of FIG. 3.

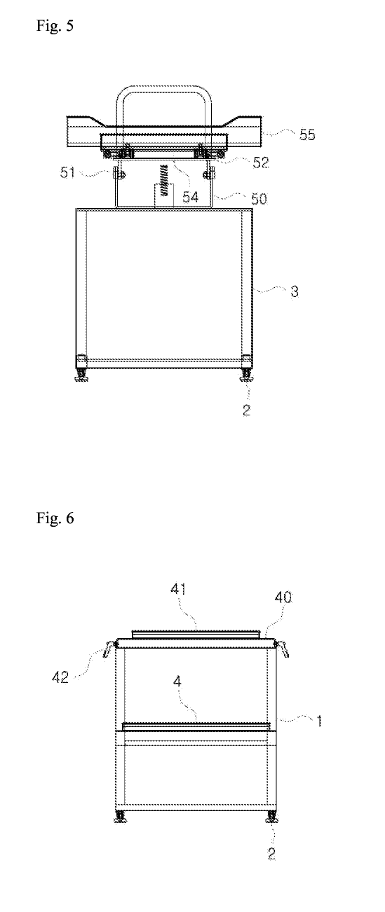

FIG. 5 is a left side of the upper body exercise part in the whole body exercise machine capable of a circular orbital motion of waist in accordance with the embodiment of the present invention. FIG. 6 is a right side of the lower body exercise part in the whole body exercise machine capable of a circular orbital motion of waist in accordance with the embodiment of the present invention.

As shown, the whole body exercise machine according to the embodiment of the present invention includes the upper body exercise part which supports the head and shoulder of a user and enables an upper body exercise, the waist exercise part which supports hip of the user and enables a waist exercise, and the lower body exercise part which supports the leg of the user and enables a lower body exercise.

The upper body exercise part 100, waist exercise part 200, and lower body exercise part 300 are horizontally arranged respectively. A main frame 1 is fixed under the lower portions of the upper body exercise part 100, waist exercise part 200, and lower body exercise part 300. A fixed part 2 and a movable caster may be formed under the main frame 1.

A quadrangular frame-shaped upper body support frame 3 is formed in the upper body exercise part 100. An angle adjustment stop bar 7 enabling an upper body support 55 including a mat to perform a seesaw movement is formed on the upper body support frame 3. A cushion protection spring 8 mediates between the angle adjustment stop bar 7 and the cushion protection spring 8 in order to control the angle adjustment.

The upper body support 55 is pivotably connected to the upper body support frame 3 by an upper body fixing bracket 50 and a rotation cam follower bearing 51.

A safety handle 58 may be attached to the leftmost end of the upper body support 55. A sliding support 54 is connected under the safety handle 58 through the mediation of a caster and a fixing bracket 53 in such a manner that the upper body support 55 can move horizontally.

The upper body support 55 is connected to a waist auxiliary support 57 by the waist exercise part 200 and an upper body connection shaft 34, and moves in association with the waist exercise part 200.

According to the configuration mentioned above, the upper body exercise part 100 not only supports the head and shoulder of the user, but also enables a seesaw movement in association with the waist exercise part 200.

The waist exercise part 200 uses a motor and a decelerator 18 as a driving source and performs a circular motion in an up and down direction by a the cam 22 and a main link 24.

The waist exercise part 200 may be divided into a circular orbital motion part and a waist support unit. The upper portion of the shown waist exercise part 200 is the waist support unit, and the lower portion of the waist exercise part 200 is the circular orbital motion part.

The waist support unit includes a waist support table 31 and a slider plate 30. The waist support table 31 supports the waist and hip of the user. The slider plate 30 is attached under the waist support table 31 in such a manner that the waist support table 31 can move horizontally. A waist support 39 is attached under the slider plate 30.

The waist support 39 is connected to an actuator 28 through the mediation of a bearing and a bracket 29 in such a manner as to adjust its height.

A side end of the waist support 39 is connected to the waist auxiliary support 57 by a link ball bearing 33. A safety handle 32 may be attached to the right and left sides of the waist support 39.

The waist support unit is composed of a two story table by the waist support 39 and the slider plate 30. This makes it possible to control the right and left movement range and to prevent an impact when the waist exercise part 200 rotates in a lateral direction.

In other words, the slider plate 30 is connected to a guide bearing block 36 there under. An impact mitigation spring 38 mediates between the guide bearing blocks 36. Therefore, when the waist support 39 moves in a lateral direction, it is possible to control the right and left movement range of the waist of the user and to mitigate the impact caused by the rotation.

The circular orbital motion part includes a link fixing bracket 27 for the connection to the waist support unit, the main link 24 connected to the link fixing bracket 27, the cam 22 which is connected to the main link 24 by a link connection shaft 23 including the bearing, a cam fixing bracket 21 which is connected to the cam 22 through the mediation of a link driven shaft 20 including the bearing, a main shaft 19 which connects both the motor and the decelerator 18 to the cam 22, and the motor and the decelerator 18 which are used as a driving source.

The cam 22 rotates about the link driven shaft 20 by a driving force of the motor and decelerator 18. In association with this, the main link 24 performs a circular orbital motion around the link connection shaft 23, and together with this, the waist support 39 connected to the main link 24 comes to perform a circular orbital motion.

A safety device may be provided, which achieves a balance of rotation when the waist support 39 perform a circular orbital motion and prevents the main link 24 from rapidly falling due to the failure of the motor, etc. This is performed by a balance safety device 25.

One end of the balance safety device 25 is connected and fixed to a balance support 26 and the other end of the balance safety device 25 is rotatably connected to the main link 24. The other end rotates with respect to the one end in association with the main link 24. The balance safety device 25 is connected to the main link 24 through the mediation of the connection shaft and the bearing.

The balance support 26 is fixed to the lower portion of the waist exercise part cover 11. The balance safety device 25 is connected to the main link 24 by a safety device fixing shaft 49.

A rotating board 10 is mounted on the main frame 1. The waist exercise part 200 is rotatably connected to the center of the rotating board 10 by a fixing bracket 16 including a bearing and a rotary shaft 15 of the rotating board 10. A fixed plate 44 may mediate between the main frame 1 and the rotating board 10.

Also, a ball caster 14 may be provided under the rotating board 10 so as to assist the rotation of the rotating board 10. The ball caster 14 not only assists the rotation of the rotating board 10, but also prevents the rotating board 10 from deflecting due to the rotation.

The rotating board 10 is configured to rotate forward and backward with respect to one direction. The direction of each of the rotations can be controlled within a range between 0 to 90 degrees.

A rotating board rotation stop bar 15 may be further formed on the outer circumferential surface of the rotating board 10 in order to rotate the rotating board 10 at a desired angle and to prevent an excessive rotation angle of the rotating board 10 caused by a rotation force.

The rotating board 10 is fixed by a fixation clamp 6. After the rotating board 10 is rotated at a desired angle in a state where the fixation clamp 6 is lifted up from the fixed plate 44, the fixation clamp 6 is fixed to the fixed plate 44, so that the rotating board 10 is completely fixed.

Owing to the fixation clamp 6, ball caster 14, and rotary shaft 15, the waist exercise part 200 is able to rotate within a range from 0 to 90 degrees. Based on FIG. 1, the waist exercise part 200 performs the lateral movement. When the waist exercise part 200 is rotated by 90 degrees based on FIG. 1, the waist exercise part 200 performs the longitudinal movement.

The lower body exercise part 300 is composed of a foothold 4, a leg support 40, and a leg support table 41. The foothold 4 is connected to the main frame 1 by a support. The leg support 40 is connected to the main frame 1. The leg support table 41 is formed on the leg support 40 and includes a mat.

The leg support 40 can be adjusted according to the body of the user by a position adjustment hole 43 formed on a side thereof and by a position adjustment clamp 42.

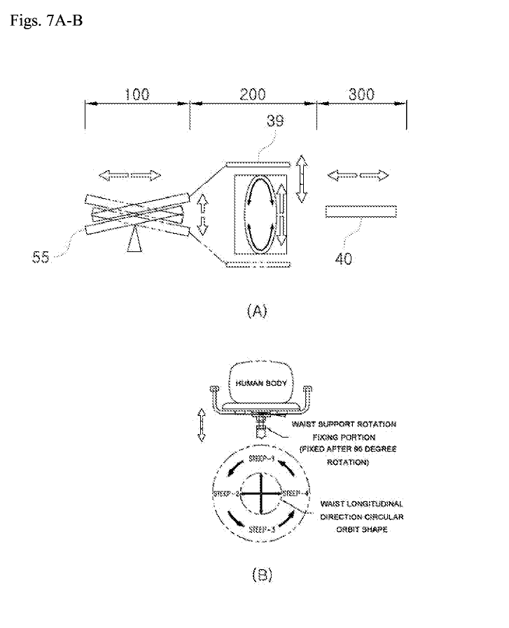

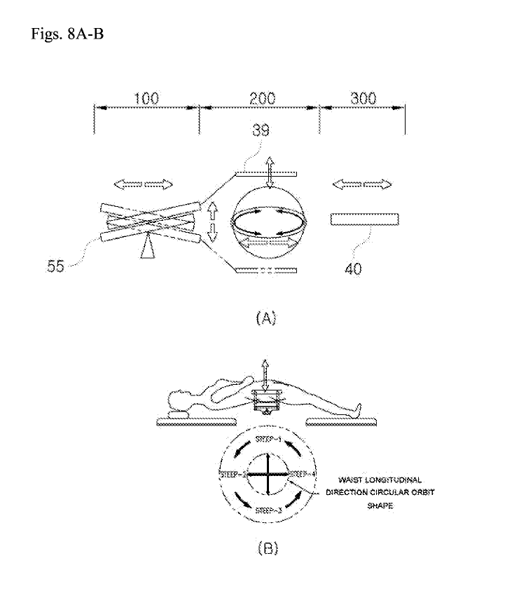

FIG. 7 is a schematic view showing a lateral movement mechanism of the whole body exercise machine capable of a circular orbital motion of waist in accordance with the embodiment of the present invention. FIG. 8 is a schematic view showing a longitudinal movement mechanism of the whole body exercise machine capable of a circular orbital motion of waist in accordance with the embodiment of the present invention.

Referring to FIG. 7, FIG. 7 shows that the waist exercise part of FIG. 1 performs the lateral movement. A schematic configuration of the front view of FIG. 1 is shown in (A) of FIG. 7. A circular motion orbit of the waist exercise part of FIG. 2 is schematically shown in (B) of FIG. 7.

Based on a direction in which the user lies down, the waist exercise part 200 performs the lateral movement in a direction of STEP-1 to STEP-4. In association with this, the upper body exercise part 100 performs a seesaw movement as well as moves horizontally. The lower body exercise part 300 independently performs a leg movement.

Referring to FIG. 8, FIG. 8 shows that the waist exercise part of FIG. 3 performs the longitudinal movement. A schematic configuration of the front view of FIG. 3 is shown in (A) of FIG. 8. A circular motion orbit of the waist exercise part of FIG. 4 is schematically shown in (B) of FIG. 8.

FIG. 8 shows that the waist exercise part 200 in the state of FIG. 7 has been rotated by 90 degrees.

Based on a direction in which the user lies down, the waist exercise part 200 performs the longitudinal movement in a direction of STEP-1 to STEP-4. In association with this, as with the lateral movement, the upper body exercise part 100 performs a seesaw movement as well as moves horizontally. The lower body exercise part 300 independently performs a leg movement.

According to the above-described configuration, the exercise for strengthening waist, back, and abdomen of the user is converted into longitudinal and lateral directional exercises on the basis of the user. Accordingly, the efficiency of the exercise can be more improved, and the longitudinal and lateral conversions can be easily made by the fixation clamp and ball caster. Also, the height of the waist support is automatically adjusted by using the independent actuator and the waist support is easy to use. The impact preventing device is mounted on the waist support, so that it is possible to control the right and left positions in the circular orbital motion and to prevent the impact. Also, the balance safety device is provided, which prevents the rotation from rapidly falling due to the failure of the motor or decelerator and accidents. As a result, the whole body exercise machine can be provided in consideration of convenience, exercise, and safety.

It can be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A whole body exercise machine which is for exercising an upper body, waist and lower body and enables a circular orbital motion of the waist, the whole body exercise machine comprising:
an upper body exercise part which supports a head or shoulder of a human body, enables an upper body exercise and moves in association with a waist exercise part;
the waist exercise part which supports the waist or hip of the human body and enables the circular orbital motion; and
a lower body exercise part which supports a leg of the human body and is horizontally movable to the right and left,
wherein the waist exercise part comprises a rotating board which rotates around a rotary shaft,
wherein one or more ball casters are formed on a lower end surface of the rotating board,
and wherein one or more fixation clamps for fixing the rotating board are formed on an outer circumferential surface of the rotating board in a circumferential direction.

2. The whole body exercise machine of claim 1, wherein the circular orbital motion is made by a vertically formed main link, a cam of which one end is connected to an end of the main link and the other end is connected to a link driven shaft, and a motor and a decelerator which transmit a driving force to the cam, and wherein a balance safety device is formed, of which one end is connected to a predetermined position of the main link by a connection shaft comprising a ball bearing and the other end is connected to a fixed balance support by the connection shaft comprising a ball bearing.

3. The whole body exercise machine of claim 1, wherein a shaft having an adjustable height is connected under the waist exercise part, and a waist support on which a slider plate is formed is located on the waist exercise part, wherein a waist support table is located on the slider plate, wherein right and left positions of the waist support table is adjusted by the slider plate, and wherein a spring for giving a cushion at the time of adjusting the position is provided in the center of the slider plate.

4. The whole body exercise machine of claim 1, wherein a waist support is formed on the waist exercise part, wherein a waist auxiliary support is formed on one side of the waist support, wherein the waist auxiliary support is coupled to an upper body connection shaft, and wherein the upper body connection shaft is connected to the upper body exercise part through the mediation of a link ball bearing.
